(19) United States
(12) Patent Application Publication
(10) Pub. No.: US 2008/0130701 A1
(43) Pub. Date: Jun. 5, 2008

(54) Gas laser apparatus and method

(75) Inventor: Mayk Van Den Hurk, Helmond (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/633,618

(22) Filed: Dec. 5, 2006

(51) Int. Cl. H01S 3/09

(52) U.S. Cl. 372/58; 372/55

(57) ABSTRACT

A gas discharge laser apparatus is disclosed. In an embodiment, the gas discharge laser apparatus includes a gas laser provided with a discharge chamber, and a gas storage chamber in controllable fluid communication with the discharge chamber via a valve member, the gas storage chamber configured to have a pressure lower therein than in the discharge chamber such that, when the valve member is controlled to bring the gas storage chamber into fluid communication with the discharge chamber, gas is removed from the discharge chamber.

### FIELD

The present invention relates to a gas laser apparatus and a method of emptying and filling a gas laser with gas.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

The beam used to irradiate target portions of the substrate may be generated by any appropriate source. In many circumstances however, the beam of radiation is generated using a gas discharge laser (often referred to as a gas laser). A gas laser is a laser in which an electric current is discharged through a gas in order to produce radiation. For example, an excimer laser is a gas laser often used in lithography. An excimer laser is used in order to generate UV radiation which is often required in lithographic processes.

### SUMMARY

The nature of the radiation generated in a gas laser is dependent upon the gas used in the laser. The gas laser must therefore be filled with an appropriate gas before it is able to generate specific radiation. Operation of the gas laser may cause depletion of the gas or contamination of the gas. Due to the nature of the gas within the laser changing over time, it is often necessary to refill the laser with new gas. In order to fill the laser with new gas, the old gas must firstly be removed from the laser, before it is filled with the new gas. The emptying and refilling of the gas laser takes time, during which the laser cannot be operated. When the laser is not operational, it can't be used to irradiate target portions of substrates, meaning that substrate patterning throughput could be reduced.

It is desirable, for example, to provide, for a gas laser apparatus and/or method that obviates or mitigates one or more of the problems of the prior art, whether identified herein or elsewhere.

According to an aspect of the invention, there is provided a gas discharge laser apparatus comprising:

a gas laser provided with a discharge chamber; and

a gas storage chamber in controllable fluid communication with the discharge chamber via a valve member, the gas storage chamber configured to have a pressure lower therein than in the discharge chamber such that, when the valve member is controlled to bring the gas storage chamber into fluid communication with the discharge chamber, gas is removed from the discharge chamber.

According to a further aspect of the invention, there is provided a gas discharge laser apparatus comprising:

a gas laser provided with a discharge chamber; and

a gas storage chamber in controllable fluid communication with the discharge chamber via a valve member, the gas storage chamber configured to store pressurized gas such that, when the valve member is controlled to bring the gas storage chamber into fluid communication with the discharge chamber, the discharge chamber is filled with the gas.

According to a further aspect of the invention, there is provided a method of removing gas from a discharge chamber of a gas discharge laser, the method comprising:

substantially evacuating a storage chamber; and

bringing the substantially evacuated storage chamber into fluid communication with the discharge chamber to remove gas from the discharge chamber.

According to a further aspect of the invention, there is provided a method of filling a discharge chamber of a gas discharge laser with gas, the method comprising:

filling a gas storage chamber with gas such that the gas becomes pressurized; and

bringing the pressurized gas storage chamber into fluid communication with the discharge chamber to fill the discharge chamber with gas.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a gas laser apparatus;

FIGS. 3A and 3B depict operational principles of the gas laser of FIG. 2;

FIG. 4 depicts a gas laser apparatus according to an embodiment of the present invention;

FIGS. 5A and 5B depict operational principles of the gas laser of FIG. 4; and

FIGS. 6A and 6B illustrate a comparison between the operational principles of the gas lasers shown in FIGS. 2 and 4.

### DETAILED DESCRIPTION

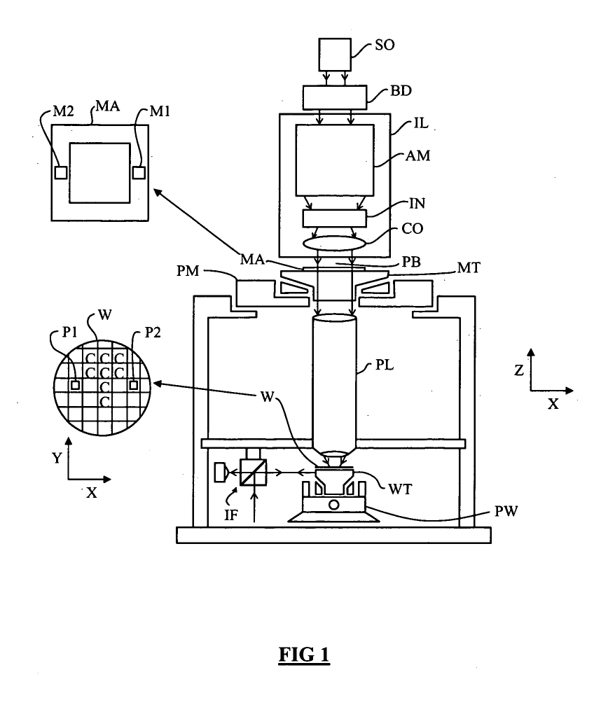

FIG. 1 schematically depicts a lithographic apparatus according to a particular embodiment of the invention. The apparatus comprises:
an illumination system (illuminator) IL to condition a beam PB of radiation (e.g. UV radiation or EUV radiation);
a support structure (e.g. a support structure) MT to support a patterning device (e.g. a mask) MA and connected to first positioning device PM to accurately position the patterning device with respect to item PL;
a substrate table (e.g. a wafer table) WT configured to hold a substrate (e.g. a resist-coated wafer) W and connected to second positioning device PW to accurately position the substrate with respect to item PL; and
a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illumination system may also encompass various types of optical components, including refractive, reflective, and catadioptric optical components for directing, shaping, or controlling the beam of radiation, and such components may also be referred to below, collectively or singularly, as a “lens”.

The illuminator IL may comprise adjusting means AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The radiation beam PB is incident on the patterning device (e.g. mask) MA, which is held on the support structure MT. Having traversed the patterning device MA, the beam PB passes through the projection system PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

The depicted apparatus can be used in the following preferred modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 depicts a gas laser apparatus. The gas laser apparatus includes a gas discharge laser 1 which may serve as the illumination source of a lithographic apparatus. The gas discharge laser 1 includes a discharge chamber 2, in which is located a reflector 3a and an output coupler 3b. A detailed description of the operation of the gas discharge laser 1 is not given here, but is well known in the art.

The discharge chamber 2 is connected to a pump 4. In turn, the pump 4 is connected to a gas storage chamber 5 and a gas scrubber 6. The pump 4 may be used to fill or empty the discharge chamber 2 of the gas discharge laser 1.

When the discharge chamber 2 needs to be emptied, valves 7 are appropriately opened or closed such that the pump 4 can pump gas from the gas discharge chamber 2 to an outlet 8 (e.g. to a gas extraction facility, vent, etc.). The pump 4 is then operated to extract the gas from the discharge chamber 2. Before being passed to the outlet 8, the gas is passed through a gas scrubber 6 in order to remove any harmful chemicals in the gas, such as fluorine.

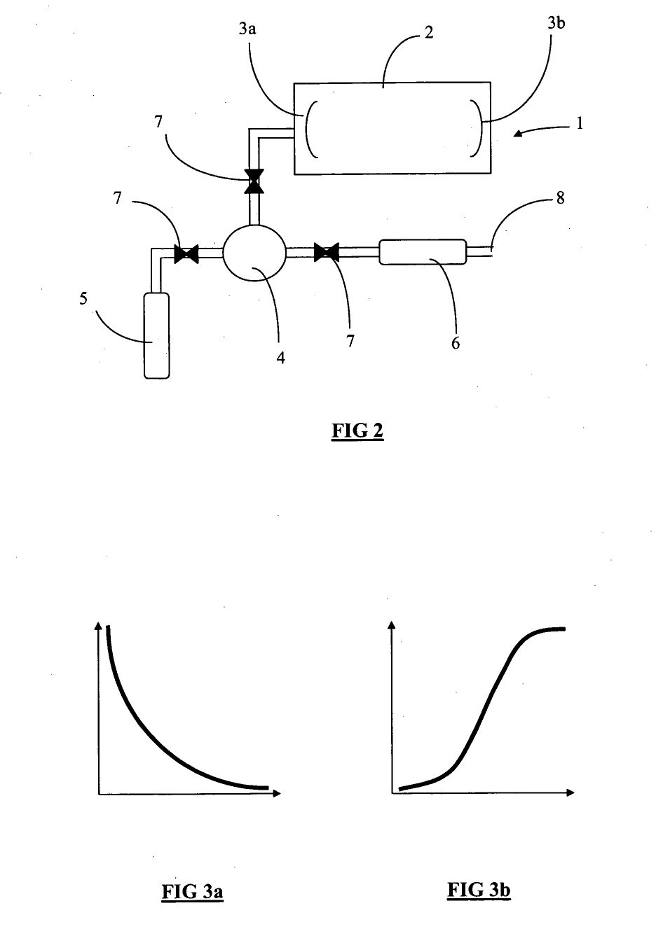

FIG. 3A depicts the gas pressure P (along the Y-axis extending up and down the page) within the discharge chamber 2 as a function of time T (along the X-axis extending across the page) when the pump 4 is extracting gas from the discharge chamber 2. It can be seen that the gas pressure decays approximately exponentially. A large amount of gas is removed from the discharge chamber 2 in a short period of time, but it then takes a much longer period of time to remove similarly large amounts of gas. Gas can be completely removed from the discharge chamber 2, or removed to a sufficient extent (e.g. a desired level) such that the pressure of the gas within the discharge chamber is negligible (e.g. such that it does not contaminate or significantly affect the properties of new gas with which the discharge chamber 2 may be provided). For example the desired level of the gas pressure can be in the range 5 to 20 kPa. This is lower than the usual operating pressure of a gas discharge laser, which may be in the range of 200 to 400 kPa (although it will be appreciated that the exact operating pressure may vary between different discharge lasers).

Referring back to FIG. 2, when a sufficient amount of gas has been removed from the discharge chamber 2 to reduce the gas pressure in the discharge chamber 2, new gas may be pumped into the discharge chamber 2. In order to pump gas into the discharge chamber 2, valves 7 of the gas apparatus are appropriately opened or closed such that gas may flow from the gas storage chamber 5 through the pump 4 and into the discharge chamber 2. Gas may not flow from the gas storage chamber 5 to the outlet 8. The pump 4 is operated to pump gas from the gas storage chamber 5 into the discharge chamber 2. It will be appreciated that the gas storage chamber 5 may contain an appropriate gas or gas mixture necessary to achieve appropriate discharge within the discharge chamber 2. For example, the gas may comprise one or more selected from helium, argon, neon, krypton and a halogen, such as fluorine. Alternatively, separate gases from a plurality of gas storage chambers may be individually or simultaneously pumped into the discharge chamber to achieve a desired gas mixture.

FIG. 3B depicts the pressure P (along the Y-axis extending up and down the page) within the discharge chamber 2 as a function of time T (along the X-axis extending across the page) as the gas from the gas storage chamber 5 is pumped into the gas discharge chamber 2. It can be seen that there is a gradual increase in the gas pressure P over a period of time.

The refilling of the discharge chamber 2 can take ten to twenty minutes or more in a gas laser used in, for example, lithography. This includes the time for emptying the discharge chamber 2 (approximately two thirds of the refill time) and also the time taken to fill the discharge chamber 2 with new gas (approximately one third of the refill time).

When the discharge chamber 2 is emptied or filled, the gas discharge laser 1 is not operational. Therefore, when the discharge chamber 2 is being emptied or filled, one or more substrates cannot be irradiated with radiation from that laser, and the throughput of the lithographic process may be reduced as a whole. A reduction in throughput can increase the costs associated with the process, and/or reduce the profitability of the process. It is therefore desirable to reduce or minimize the time taken to empty and refill the discharge chamber 2 of the gas discharge laser 1.

Various solutions have been proposed to reduce the time taken to empty and refill the discharge chamber 2 of the gas discharge laser 1. One proposed solution is the use of more powerful pumping equipment. However, more powerful pumping equipment often requires more regular servicing than less powerful pumping equipment. The laser is not operable when the more powerful pump is being serviced, meaning that the throughput of a process using this solution may be reduced. A more powerful pump may also require more lubrication, and the substance used to lubricate the pump (e.g. lubricating oil) may, over time, enter the discharge chamber 2 and contaminate the gas within the chamber 2. Contamination of the gas within the discharge chamber 2 can affect the optical properties of radiation discharged from a discharge chamber 2, or even prevent discharge from gas within the discharge chamber 2. Furthermore, a more powerful pump requires more electrical power to operate, and may also take up more space which can be valuable in and around a lithographic apparatus, for example.

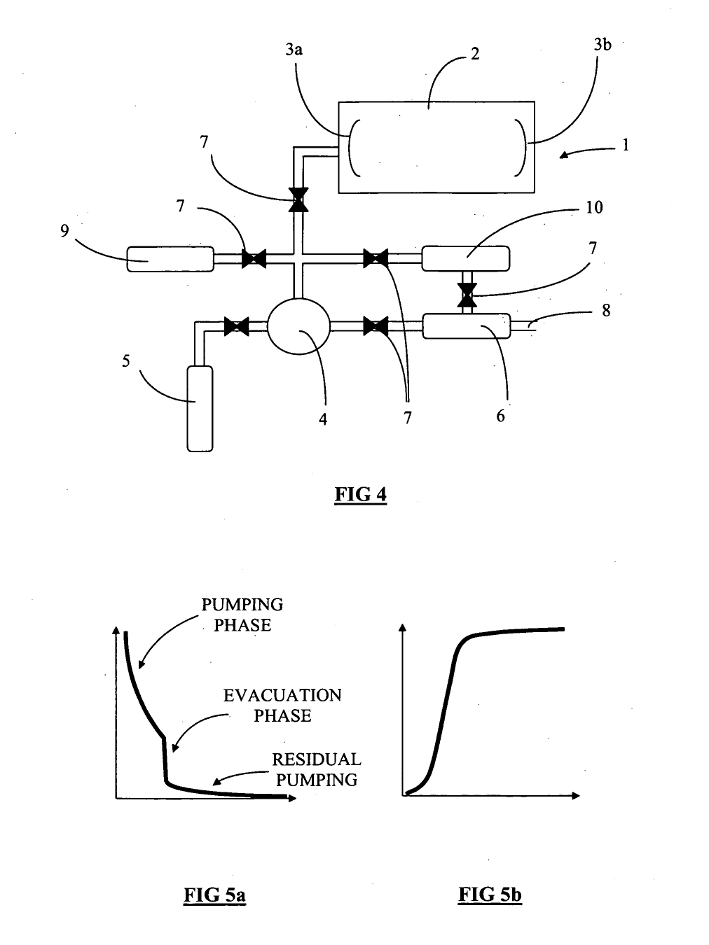

FIG. 4 illustrates a gas discharge laser apparatus according to an embodiment of the present invention. Features of the apparatus of FIG. 4 which also appear in the apparatus of FIG. 2 are given identical reference numerals.

As described in relation to FIG. 2, the gas discharge laser apparatus of FIG. 4 includes a gas discharge laser 1 which is provided with a gas discharge chamber 2. A reflector 3a and output coupler 3b are provided inside the discharge chamber 2. The discharge chamber 2 is connected to a pump 4 which is in turn connected to a gas storage chamber 5 and gas scrubber 6. The gas discharge laser apparatus of FIG. 4 is also provided with a further gas storage chamber 9 and a gas evacuation chamber 10, the significance of which will be described in more detail below.

In use, the gas evacuation chamber 10 of the gas discharge laser apparatus is substantially evacuated, or at least at a lower gas pressure than the gas in the discharge chamber 2. The pressure in the gas evacuation chamber 10 may be reduced using the pump 4, or any other suitable means. The pressure in the gas evacuation chamber 10 may be reduced by the pump 4 when the gas discharge laser 1 is in operation. Valves 7 are appropriately opened or closed such that the pump 4 is only in fluid communication with the gas evacuation chamber 10.

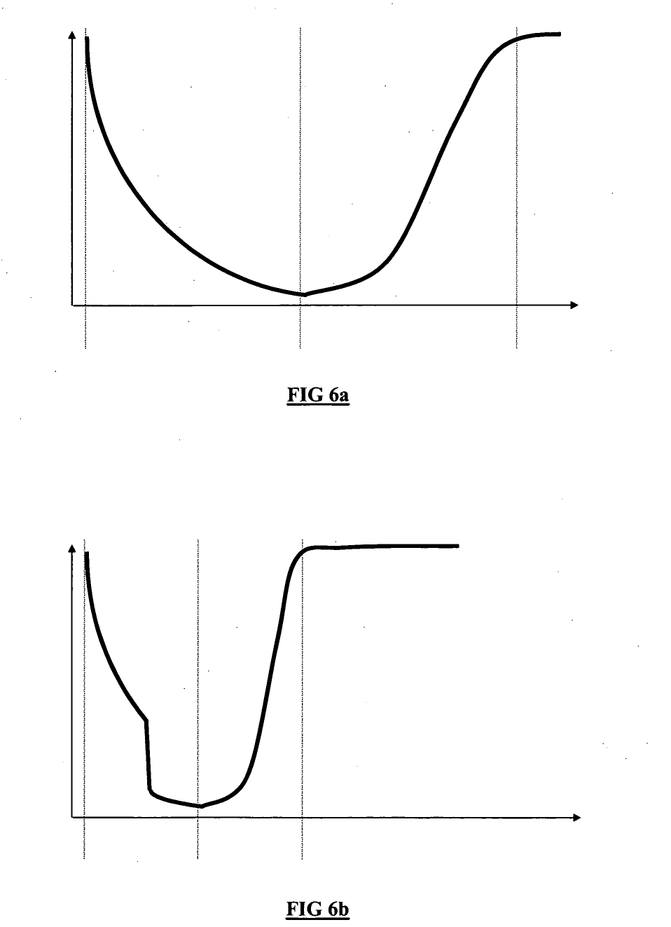

When it becomes necessary to empty the discharge chamber 2, valves 7 may be appropriately opened or closed such that the pump 4 may pump gas from the discharge chamber 2 and through the gas scrubber 6 to an outlet 8. FIG. 5A illustrates the gas pressure P (along the Y-axis extending up and down the page) within the discharge chamber 2 as a function of time T (along the X-axis extending across the page). The phase in which the pump 4 draws gas from the discharge chamber 2 is identified by the term “pumping phase”. As described in relation to FIG. 3A, the pump 4 is able to remove a large quantity of gas from the discharge chamber 2 in a relatively short period of time. With the apparatus shown in FIG. 2, it took increasingly longer periods of time to remove similarly large quantities of gas from the discharge chamber 2. However, this long process of emptying the discharge chamber 2 is remedied using the apparatus of FIG. 4. Referring back to FIG. 4, when the pump has removed a large quantity of gas from the discharge chamber 2, a valve 7 may be opened such that the gas evacuation chamber 10 is now in fluid communication with the discharge chamber 2, instead of the pump 4. When the gas evacuation chamber 10 is in fluid communication with the discharge chamber 2, gas within the discharge chamber 2 is very quickly drawn into the space provided in the gas evacuation chamber 10. It can be seen from FIG. 5A that a large quantity of gas is removed over a very short period of time. Therefore, the provision of an evacuation chamber 10 allows gas to be quickly removed from the gas discharge chamber 2. The phase in which the gas evacuation chamber 10 draws gas from the discharge chamber 2 is identified in FIG. 5A by the term “evacuation phase”.

After a period of time, the gas pressure within the discharge chamber 2 will be the same as the gas pressure within the gas evacuation chamber 10 (i.e. an equilibrium stage will be reached). The volume or pressure of the gas evacuation chamber 10 can be chosen such that at the equilibrium stage, the amount of gas remaining in the gas discharge chamber 2 is small or negligible, e.g., that it is insufficient to contaminate or affect the discharge properties of new gas which the discharge chamber may be filled with. More than one gas evacuation chamber 10 may be provided to reduce the gas pressure in the discharge chamber to this desired level. It will be appreciated that other factors may need to be taken into account, such as ambient temperatures, the size of tubing connecting the discharge chamber 2 to the gas evacuation chamber 10, etc.

When the gas has been removed from the gas discharge chamber 2, it can be passed to the gas scrubber 6 by appropriate opening and closing of valves 7. The cleaned gas can then be passed to the outlet 8. If required, the valves 7 may be appropriately opened or closed such that pumping of a small amount of residual gas from a discharge chamber 2 can be achieved. This is designated as “residual pumping” in FIG. 5A.

Referring back to FIG. 2, it was described how the filling of the discharge chamber 2 took a long period of time. This is not the case with the apparatus of FIG. 4, due to the provision of the further gas storage chamber 9, as will now be described in more detail. Referring back to FIG. 4, when the gas discharge laser 1 is operating, the pump 4 may be operated, and valves 7 appropriately opened or closed such that the pump 4 may pump gas from the gas storage chamber 5 into the further gas storage chamber 9. The pump 4 pumps gas into the further gas storage chamber 9 such that the gas in the further gas storage chamber 9 is at a higher pressure than the gas in the gas storage chamber 5. When it is necessary to fill the discharge chamber 2 with gas, valves 7 may be appropriately opened or closed such that the discharge chamber 2 is in fluid communication with the further gas storage chamber 9. Since the gas in the further gas storage chamber 9 is pressurized, it will rush into the discharge chamber 2 and quickly fill it with gas, as shown in FIG. 5b which shows the gas pressure P (along the Y-axis extending up and down the page) within the discharge chamber 2 as a function of time T (along the X-axis extending across the page).

Properties of the discharge chamber 2, further gas storage chamber 9, tubing connecting the further gas storage chamber 9 to the discharge chamber 2, and also the gas itself are taken into account in order to ensure that when the further gas storage chamber 9 is in fluid communication with the discharge chamber 2, the gas pressure in the discharge chamber 2 settles at a desired level. For example, the volume of the further gas storage chamber 9 will need to be taken into account, as well as the pressure of the gas stored in the further gas storage chamber 9, in order to ensure that, at equilibrium, the gas pressure in the discharge chamber 2 is the desired gas pressure (e.g. the operating gas pressure of the gas discharge laser 1).

It will be appreciated that a desired gas or gas mixture may be pumped under pressure into the gas further storage chamber 9 directly from one or more gas storage chambers 5. Alternatively, a desired and pressurized gas mixture may be created by pumping different gases into the further storage chamber 9 from different gas storage chambers 5.

FIG. 6a is a plot of the gas pressure P (along the Y-axis extending up and down the page) within the discharge chamber 2 of the gas laser apparatus of FIG. 2 as a function of time T (along the X-axis extending across the page). The gas pressure is shown to decrease slowly as the gas is emptied from the discharge chamber 2, and then rise slowly as the discharge chamber 2 is filled with new gas. FIG. 6b shows a plot of the gas pressure P (along the Y-axis extending up and down the page) within the discharge chamber 2 of the apparatus of FIG. 4 as a function of time T (along the X-axis extending across the page). It can be seen that the gas pressure falls quickly as the gas is emptied from the discharge chamber 2, and then rises quickly as the discharge chamber 2 is filled with new gas. It can be seen from a comparison of FIGS. 6a and 6b that both the emptying and filling times are reduced using the apparatus and method described in relation to FIG. 4. This means that the gas discharge laser 1 of FIG. 4 is operational for a greater period of time than the gas discharge laser 1 of FIG. 2. Since the gas discharge laser 1 of FIG. 4 is operational for a greater period of time, the throughput of a lithographic process (or any other process) using the apparatus of FIG. 4 as an illumination source may be increased. Increasing the throughput of the process can reduce costs and/or increase the profitability of the process (for example, allowing more substrates to be patterned).

The fact that the pressure in the gas evacuation chamber 10 is reduced when the gas laser 1 is operating, and/or the further gas storage chamber 9 is filled when the gas laser 1 is operating, also helps to reduce downtime. Furthermore, because more powerful pumping equipment is not required using the apparatus or method according to an embodiment of the present invention, the risk of contaminating gases with, for example, a lubricating oil, is reduced.

It may not be possible to reduce the pressure in the gas evacuation chamber 10, and/or fill the further gas storage chamber 9, when the gas laser is operating. For example, vibrations of the laser when it is operating may make it difficult or impractical to reduce the pressure in the gas evacuation chamber 10, and/or fill the further gas storage chamber 9. If such difficult or impractical conditions arise, the gas evacuation chamber 10 may have the pressure therein reduced, and/or the further gas storage chamber 9 filled when the laser is not operating. The further gas storage chamber 9 may be filled when the discharge chamber 2 is being emptied, or when the gas evacuation chamber 10 is having its pressure therein reduced. Similarly, the gas evacuation chamber 10 may have the pressure therein reduced when the further gas storage chamber 9 is being filled, or when the discharge chamber 2 is being filled.

In the above mentioned embodiments, the gas scrubber 6 is described as being between the pump 4 and the outlet 8. It will be appreciated that another arrangement is possible, for example the gas scrubber 8 being positioned between the discharge chamber 2 and the pump 4. It will also be appreciated that the gas laser apparatus may be provided with one or more pumps. For example, one pump could be provided to fill the further gas storage chamber 9, and another to reduce the pressure in the gas evacuation chamber 10.

In above mentioned embodiments, the gas laser 1 has been described as having a single discharge chamber 2. It will be appreciated that a gas laser can have one or more discharge chambers, and that the apparatus and methods described above can be used to fill or empty the one or more discharge chambers.

Although the gas discharge laser 1 has been described as the illumination source of a lithographic apparatus, it is to be appreciated that the apparatus and method described is applicable to any gas discharge laser. For example, the apparatus and method may be used in any application where a gas discharge laser is required. The apparatus and method according to embodiments of the present invention is particularly useful when it is required to shorten the period of time taken to empty and/or refill the discharge chamber of a gas discharge laser.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

While specific embodiments of the invention have been described above, it will be appreciated that the invention may be practiced otherwise than as described. The description is not intended to limit the invention.

1. A gas discharge laser apparatus comprising:
a gas laser provided with a discharge chamber; and
a gas storage chamber in controllable fluid communication with the discharge chamber via a valve member, the gas storage chamber configured to have a pressure lower therein than in the discharge chamber such that, when the valve member is controlled to bring the gas storage chamber into fluid communication with the discharge chamber, gas is removed from the discharge chamber.

2. The gas discharge laser apparatus of claim 1, further comprising a pump arranged to substantially evacuate the gas storage chamber.

3. The gas discharge laser apparatus of claim 1, wherein the gas storage chamber is configured such that, when the gas storage chamber is in fluid communication with the discharge chamber, the gas pressures within the gas storage chamber and the discharge chamber settle at, above or below a desired value.

4. The gas discharge laser apparatus of claim 3, wherein the gas storage chamber is configured such that, when the gas storage chamber is in fluid communication with the discharge chamber, the gas pressures within the gas storage chamber and the discharge chamber settle at or below the desired value, and wherein the desired value is insufficient to substantially affect the performance of the gas laser when the discharge chamber is filled with new gas.

5. The gas discharge laser apparatus of claim 3, wherein the volume of the gas storage chamber is configured such that, when the gas storage chamber is in fluid communication with the discharge chamber, the gas pressures within the gas storage chamber and the discharge chamber settle at, above or below the desired value.

6. The gas discharge laser apparatus of claim 3, wherein the gas storage chamber is arranged to be evacuated to such an extent such that, when the gas storage chamber is in fluid communication with the discharge chamber, the gas pressures within the gas storage chamber and the discharge chamber settle at, above or below the desired value.

7. The gas discharge laser apparatus of claim 1, further comprising a further gas storage chamber in controllable fluid communication with the discharge chamber, the further gas storage chamber configured to store pressurized gas such that, when the further gas storage chamber is brought into fluid communication with the discharge chamber, the discharge chamber is filled with the gas.

8. The gas discharge laser apparatus of claim 7, wherein the further gas storage chamber is configured such that, when the further gas storage chamber is in fluid communication with the discharge chamber, the gas pressures within the further gas storage chamber and the discharge chamber settle at, above or below a second desired value.

9. The gas discharge laser apparatus of claim 7, further comprising a pump arranged to pump gas into the further gas storage chamber and to pressurize the gas.

10. The gas discharge laser apparatus of claim 7, further comprising a pump arranged to pump gas into the further gas storage chamber from a third gas storage chamber.

11. The gas discharge laser apparatus of claim 8, wherein the volume of the further gas storage chamber is configured such that, when the further gas storage chamber is in fluid communication with the discharge chamber, the gas pressures within the further gas storage chamber and the discharge chamber settle at, above or below the second desired value.

12. The gas discharge laser apparatus of claim 8, wherein the further gas storage chamber is arranged to store gas of a sufficient pressure such that, when the further gas storage chamber is in fluid communication with the discharge chamber, the gas pressures within the further gas storage chamber and the discharge chamber settle at, above or below the second desired value.

13. The gas discharge laser apparatus of claim 8, wherein the further gas storage chamber is configured such that, when the further gas storage chamber is in fluid communication with the discharge chamber, the gas pressures within the further gas storage chamber and the discharge chamber settle at or above the second desired value, and wherein the second desired value corresponds to a minimum operating gas pressure of the gas laser.

14. A gas discharge laser apparatus comprising:
a gas laser provided with a discharge chamber; and
a gas storage chamber in controllable fluid communication with the discharge chamber via a valve member, the gas storage chamber configured to store pressurized gas such that, when the valve member is controlled to bring the gas storage chamber into fluid communication with the discharge chamber, the discharge chamber is filled with the gas.

15. The gas discharge laser apparatus of claim 14, wherein the gas storage chamber is configured such that, when the gas storage chamber is in fluid communication with the discharge chamber, the gas pressures within the gas storage chamber and the discharge chamber settle at, above or below a desired value.

16. The gas discharge laser apparatus of claim 14, further comprising a pump arranged to pump gas into the gas storage chamber and to pressurize the gas.

17. The gas discharge laser apparatus of claim 14, further comprising a pump arranged to pump gas into the gas storage chamber from a further gas storage chamber.

18. The gas discharge laser apparatus of claim 15, wherein the volume of the gas storage chamber is configured such that, when the gas storage chamber is in fluid communication with the discharge chamber, the gas pressures within the gas storage chamber and the discharge chamber settle at, above or below the desired value.

19. The gas discharge laser apparatus of claim 15, wherein the gas storage chamber is arranged to store gas of a sufficient pressure such that, when the gas storage chamber is in fluid communication with the discharge chamber, the gas pressures within the gas storage chamber and the discharge chamber settle at, above or below the desired value.

20. The gas discharge laser apparatus of claim 15, wherein the gas storage chamber is configured such that, when the gas storage chamber is in fluid communication with the discharge chamber, the gas pressures within the gas storage chamber and the discharge chamber settle at or above the desired value, and wherein the desired value corresponds to a minimum operating gas pressure of the gas laser.

21. The gas discharge laser apparatus of claim 14, further comprising a further gas storage chamber in controllable fluid communication with the discharge chamber, the further gas storage chamber configured to be substantially evacuated such that, when the further gas storage chamber is brought into fluid communication with the discharge chamber, gas is removed from the discharge chamber.

22. The gas discharge laser apparatus of claim 21, wherein the further gas storage chamber is configured such that, when the further gas storage chamber is in fluid communication with the discharge chamber, the gas pressures within the further gas storage chamber and the discharge chamber settle at, above or below a second desired value.

23. The gas discharge laser apparatus of claim 21, further comprising a pump arranged to substantially evacuate the further gas storage chamber.

24. The gas discharge laser apparatus of claim 22, wherein the volume of the further gas storage chamber is configured such that, when the further gas storage chamber is in fluid communication with the discharge chamber, the gas pressures within the further gas storage chamber and the discharge chamber settle at, above or below the second desired value.

25. The gas discharge laser apparatus of claim 22, wherein the further gas storage chamber is arranged to be evacuated to such an extent such that, when the further gas storage chamber is in fluid communication with the discharge chamber, the gas pressures within the further gas storage chamber and the discharge chamber settle at, above or below the second desired value.

26. The gas discharge laser apparatus of claim 22, wherein the further gas storage chamber is configured such that, when the further gas storage chamber is in fluid communication with the discharge chamber, the gas pressures within the further gas storage chamber and the discharge chamber settle at or below the desired value, and wherein the desired value is insufficient to substantially affect performance of the gas laser when the discharge chamber is filled with new gas.

27. A method of removing gas from a discharge chamber of a gas discharge laser, the method comprising:
substantially evacuating a storage chamber; and
bringing the substantially evacuated storage chamber into fluid communication with the discharge chamber to remove gas from the discharge chamber.

28. The method of claim 27, wherein the storage chamber is substantially evacuated when the gas discharge laser is operating.

29. The method of claim 27, wherein gas is pumped out of the storage chamber to substantially evacuate the storage chamber.

30. The method of claim 27, wherein some of the gas is pumped out of the discharge chamber before the discharge chamber is brought into fluid communication with the storage chamber.

31. The method of claim 27, wherein a pump is used to substantially evacuate the storage chamber, and the same pump is used to pump out some of the gas from the discharge chamber before the discharge chamber is brought into fluid communication with the storage chamber.

32. The method of claim 27, wherein the storage chamber is brought into fluid communication with the discharge chamber by opening a valve.

33. A method of filling a discharge chamber of a gas discharge laser with gas, the method comprising:
filling a gas storage chamber with gas such that the gas becomes pressurized; and
bringing the pressurized gas storage chamber into fluid communication with the discharge chamber to fill the discharge chamber with gas.

34. The method of claim 33, wherein the gas storage chamber is filled when the gas discharge laser is operating.

35. The method of claim 33, wherein gas is pumped into the gas storage chamber.

36. The method of claim 33, wherein the gas storage chamber is brought into fluid communication with the discharge chamber by opening a valve.
